(19) United States
(12) Patent Application Publication
(10) Pub. No.: US 2017/0063213 A1
(43) Pub. Date: Mar. 2, 2017

(54) FLYBACK CONVERTER

(71) Applicant: LITE-ON TECHNOLOGY CORP., Taipei (TW)

(72) Inventors: CHENG-TAI LIN, TAIPEI (TW); TING-YI HSU, TAIPEI (TW); CHENG-HUNG LIN, TAIPEI (TW); MING-TSUNG HSIEH, TAIPEI (TW); YU-KANG LO, TAIPEI (TW)

(21) Appl. No.: 15/134,809

(22) Filed: Apr. 21, 2016

Related U.S. Application Data
(60) Provisional application No. 62/211,996, filed on Aug. 31, 2015.

(51) Int. Cl. H02M 1/08; H02M 3/335

(52) U.S. Cl. CPC H02M 1/08; H02M 3/33507; H02M 2001/0054

(57) ABSTRACT

A flyback converter includes: a transformer including a primary winding and a secondary winding; a first switch coupled to the primary winding; a first control module configured to control the first switch; a second switch coupled to the secondary winding; and a second control module configured to control the second switch, such that the second switch operates in an ON state during a first time period and during a second time period which follows the first time period, and such that a current flowing through the secondary winding has a direction during the second time period opposite to that during the first time period.

### CROSS-REFERENCE TO RELATED APPLICATION

This application claims priority of U.S. Provisional Application No. 62/211,996, filed on Aug. 31, 2015, currently pending.

### FIELD

The disclosure relates to power conversion, and more particularly to a flyback converter.

### BACKGROUND

A conventional flyback converter disadvantageously has a relatively high switching loss, and thus has a relatively low conversion efficiency.

### SUMMARY

Therefore, an object of the disclosure is to provide a flyback converter that can alleviate the drawback of the prior art.

According to one aspect of the disclosure, the flyback converter includes a transformer, a first switch, a first control module, a second switch and a second control module. The transformer includes a primary winding and a secondary winding. Each of the windings has a first terminal and a second terminal. The first terminals respectively of the primary and secondary windings have the same voltage polarity. The first switch is coupled to the first terminal of the primary winding. The first control module is coupled to the first switch, and is configured to control the first switch. The second switch is coupled to the secondary winding. The second control module is coupled to the second switch, and is configured to control the second switch, such that the second switch operates in an ON state during a first time period and during a second time period which is right after the first time period, and such that a current flowing through the secondary winding has a direction during the second time period opposite to that during the first time period.

According to another aspect of the disclosure, the flyback converter includes a transformer, a first switch, a first control module, a second switch and a second control module. The transformer includes a primary winding and a secondary winding. Each of the windings has a first terminal and a second terminal. The first terminals respectively of the primary and secondary windings have the same voltage polarity. The first switch is coupled to the first terminal of the primary winding. The first control module is coupled to the first switch, and is configured to control the first switch. The second switch is coupled to the secondary winding. The second control module is coupled to the second switch, and is configured to control the second switch, such that the second switch operates in an ON state during a first time period and during a second time period which follows the first time period, and such that a current flowing through the secondary winding has a direction during the second time period opposite to that during the first time period.

### BRIEF DESCRIPTION OF THE DRAWINGS

Other features and advantages of the disclosure will become apparent in the following detailed description of the embodiment with reference to the accompanying drawings, of which:

FIG. 1 is a circuit block diagram illustrating an embodiment of a flyback converter according to the disclosure; and

FIGS. 2 and 3 are timing diagrams illustrating operation of the embodiment in various conditions.

### DETAILED DESCRIPTION

Before describing this disclosure in detail, it should be noted herein that throughout this disclosure, when two elements are described as being “coupled in series,” “connected in series” or the like, it is merely intended to portray a serial connection between the two elements without necessarily implying that the currents flowing through the two elements are identical to each other and without limiting whether or not an additional element is coupled to a common node between the two elements. Essentially, “a series connection of elements,” “a series coupling of elements” or the like as used throughout this disclosure should be interpreted as being such when looking at those elements alone.

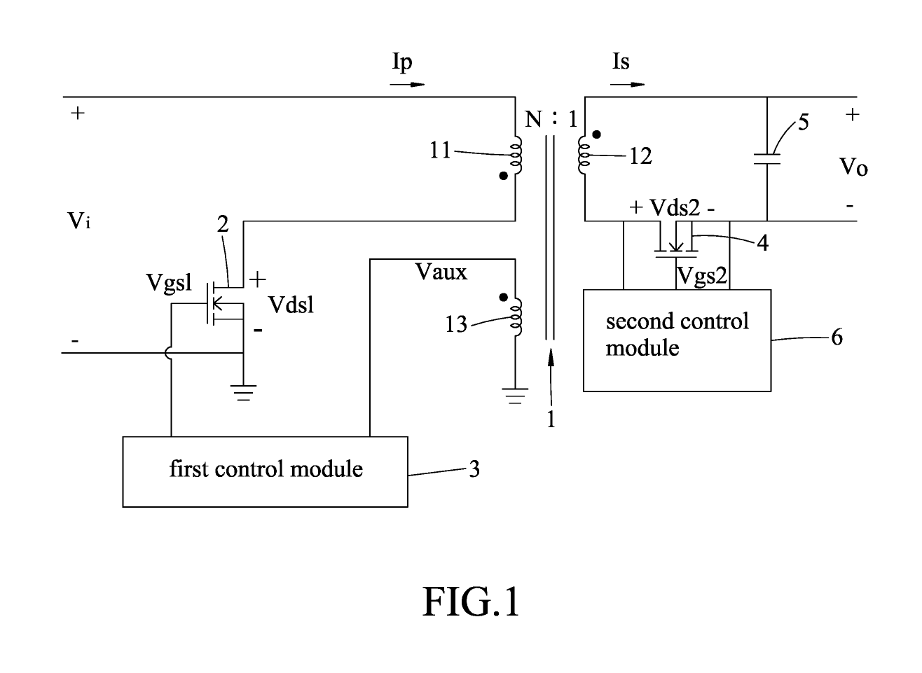

Referring to FIGS. 1 to 3, an embodiment of a flyback converter according to the disclosure is used to convert an input voltage (Vi) into an output voltage (Vo), and includes a transformer 1, a first switch 2, a first control module 3, a second switch 4, an output capacitor 5 and a second control module 6.

The transformer 1 includes a primary winding 11, a secondary winding 12 and an auxiliary winding 13. Each of the primary, secondary and auxiliary windings 11, 12, 13 has a first terminal (e.g., a dot-marked terminal shown in FIG. 1) and a second terminal (e.g., a non-dotted terminal shown in FIG. 1). The first terminals respectively of the primary, secondary and auxiliary windings 11, 12, 13 have the same voltage polarity. The primary winding 11 has a number of turns N times that of the secondary winding 12 (i.e., a turn ratio of the primary winding 11 to the secondary winding 12 is N), and is used to receive the input voltage (Vi) at the second terminal thereof.

The first switch 2 has a first terminal that is coupled to the first terminal of the primary winding 11, a second terminal that is grounded, and a control terminal. In this embodiment, the first switch 2 is an N-type metal oxide semiconductor field effect transistor (nMOSFET) having a drain terminal, a source terminal and a gate terminal that respectively serve as the first, second and control terminals of the first switch 2.

The first control module 3 is coupled to the first terminal of the auxiliary winding 13 and the control terminal of the first switch 2, generates a first control signal (Vgs1) in response to a voltage (Vaux) at the first terminal of the auxiliary winding 13 and a predetermined time threshold (Tth), and outputs the first control signal (Vgs1) to the control terminal of the first switch 2 so as to control operation of the first switch 2 between an ON state and an OFF state. The first control signal (Vgs1) switches between a first state (e.g., being at a logic high level, and corresponding to the ON state of the first switch 2) and a second state (e.g., being at a logic low level, and corresponding to the OFF state of the first switch 2). Under the control of the first control module 3, the first switch 2 operates in the OFF state for at least the predetermined time threshold (Tth), and transitions from the OFF state to the ON state when a voltage (Vds1) across the first switch 2 is determined, in response to the voltage (Vaux) at the first terminal of the auxiliary winding 13, to reach its valley.

It should be noted that the flyback converter of this embodiment further includes components (not shown) for providing signals to assist the first control module 3 in deciding when to make the first switch 2 transition from the ON state to the OFF state. Configuration and operation of such components and how the first control module 3 makes the decision are well known to those skilled in the art, and details thereof are omitted herein for the sake of brevity.

The second switch 4 and the output capacitor 5 are coupled in series across the secondary winding 12. The second switch 4 has a first terminal that is coupled to the second terminal of the secondary winding 12, a second terminal and a control terminal. The output capacitor 5 is coupled between the first terminal of the secondary winding 12 and the second terminal of the second switch 4, and a voltage thereacross serves as the output voltage (Vo). In this embodiment, the second switch 4 is an nMOSFET having a drain terminal, a source terminal and a gate terminal that respectively serve as the first, second and control terminals of the second switch 4.

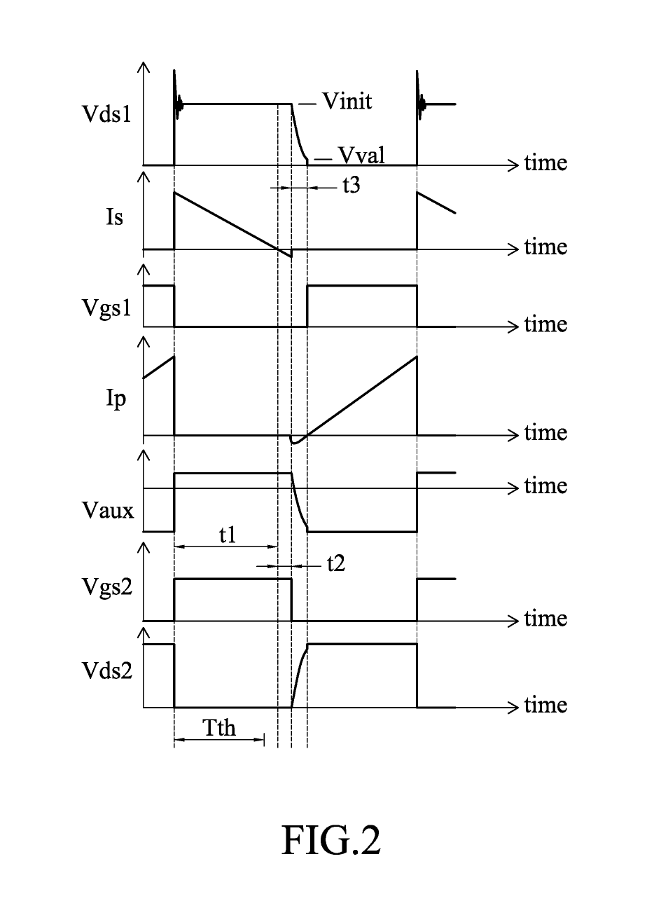

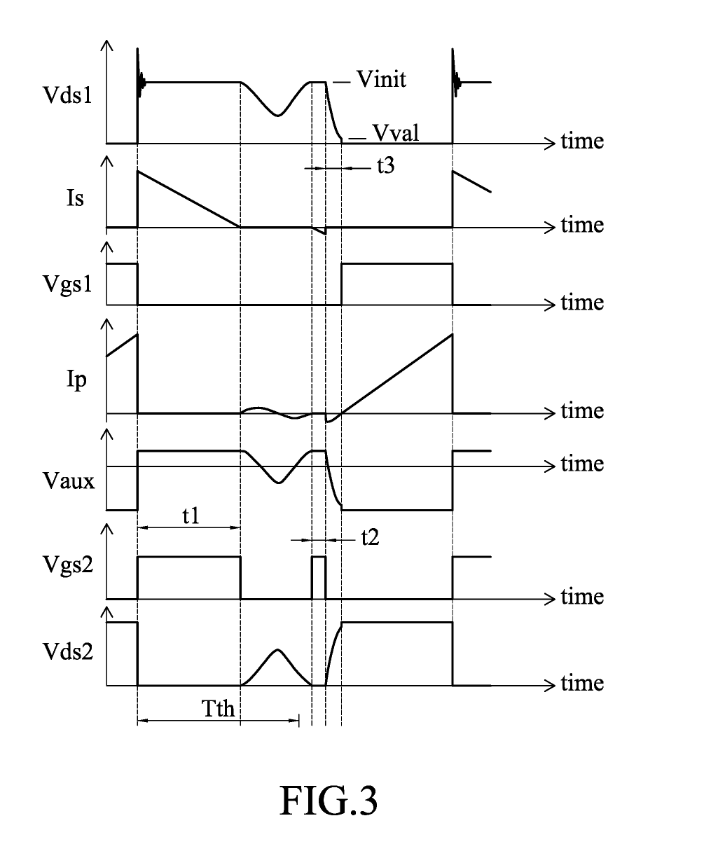

The second control module 6 is coupled to the first, second and control terminals of the second switch 4, and generates, in response to a voltage (Vds2) across the second switch 4, a voltage detection signal indicating the input voltage (Vi). The second control module 6 further generates a second control signal (Vgs2) in response to the voltage (Vds2) across the second switch 4, the predetermined time threshold (Tth) and the voltage detection signal, and outputs the second control signal (Vgs2) to the control terminal of the second switch 4 so as to control operation of the second switch 4 between an ON state and an OFF state. The second control signal (Vgs2) switches between a first state (e.g., being at a logic high level, and corresponding to the ON state of the second switch 4) and a second state (e.g., being at a logic low level, and corresponding to the OFF state of the second switch 4). Under the control of the second control module 6, the second switch 4 operates in the ON state during a first time period that has a duration of t1, and a second time period that has a duration of t2 and that follows the first time period, and operates in the OFF state otherwise. In the first time period, a current (Is) flowing through the secondary winding 12 is determined, in response to the voltage (Vds2) across the second switch 4, to have a non-zero magnitude and a direction from the second terminal of the secondary winding 12 to the first terminal of the secondary winding 12. As shown in FIG. 2, when the duration of the first time period is determined to be greater than the predetermined time threshold (Tth), i.e., t1>Tth, the second time period starts from an end of the first time period (i.e., the second time period is right after the first time period). As shown in FIG. 3, when the duration of the first time period is determined to be less than the predetermined time threshold (Tth), i.e., t1<Tth, the second time period starts from a time point which lags a start of the first time period by at least the predetermined time threshold (Tth), and at which the voltage (Vds2) across the second switch 4 is determined to reach its valley. The duration of the second time period is a function of the input voltage (Vi), i.e., t2=f(Vi).

As a result, during the second time period, the current (Is) flowing through the secondary winding 12 has the non-zero magnitude and the direction opposite to that during the first time period; during a third time period that has a duration of t3 and that starts from an end of the second time period, a current (Ip) flowing through the primary winding 11 has a non-zero magnitude and a direction from the first terminal of the primary winding 11 to the second terminal of the primary winding 11, and the voltage (Vds1) across the first switch 2 gradually decreases from an initial value (Vinit) of (Vi+N×Vo) to a valley value (Vval) that is smaller than the initial value (Vinit) and that is greater than or equal to zero (i.e., 0≦Vval<Vinit).

In this embodiment, in order to make the voltage (Vds1) across the first switch 2 decrease to a predetermined target valley value at an end of the third time period, the duration of the second time period is determined according to the following equation:

$$t 2 = f ( Vi ) = \frac{Lm \cdot C}{N \cdot Vo} \cdot \sqrt{\frac{1}{Lm \cdot C}} \cdot \sqrt{{( Vi - Vval\_t )}^{2} - {( Vinit - Vi )}^{2}} , \qquad Equation 1$$

and the duration of the third time period required for the voltage (Vds1) across the first switch 2 to reach the predetermined target valley value meets the following equation:

$$t 3 = \frac{{cos}^{- 1} [ \frac{Vval\_t - Vi}{\sqrt{\begin{matrix}{( Vi - Vinit )}^{2} + \\ {( \frac{N \cdot Vo}{Lm} \cdot t 2 \cdot \sqrt{\frac{Lm}{C}} )}^{2}\end{matrix}}} ] - {tan}^{- 1} ( \frac{\frac{N \cdot Vo}{Lm} \cdot t 2 \cdot \sqrt{\frac{Lm}{C}}}{Vi - Vinit} )}{\sqrt{\frac{1}{Lm \cdot C}}} , \qquad Equation 2$$

where Lm denotes a magnetizing inductance of the primary winding 11, C denotes a parasitic capacitance seen across the first switch 2, and Vval_t denotes the predetermined target valley value. When the predetermined target valley value is determined to be zero and the duration of the second time period is determined according to Equation 1, the first switch 2 transitions from the OFF state to the ON state with zero voltage switching.

The second time period generally includes a range of 0.1 μs to 3 μs in duration, and the third time period generally includes a range of 0.1 μs to 0.7 μs induration. In an example where Vi=380V, Vo=20V, N=6, Lm=600 μH, C=60 pF, Vinit=500V and Vval_t=0V, the duration of the second time period is 0.57 μs (t2=0.57 μs), and the duration of the third time period is 0.354 μs (t3=0.359 μs).

In view of the above, the flyback converter of this embodiment has the following advantages:

1. With the first switch 2 operating in the ON state during the properly determined second time period in addition to the first time period, the voltage across (Vds1) the first switch 2 can decrease to a sufficiently low valley value (Vval), which results in a relatively low switching loss of the first switch 2 and thus a relatively high conversion efficiency of the flyback converter of this embodiment.

2. With the predetermined time threshold (Tth), each of the first and second switches 2, 4 operates at a switching frequency that is limited below a certain frequency, which results in a relatively low switching loss of each of the first and second switches 2, 4 and thus a relatively high conversion efficiency of the flyback converter of this embodiment.

3. With the duration of the second time period being a function of the input voltage (Vi), the valley value (Vval) can be unchanged over a relatively wide range of input voltages (Vi).

It should be noted that in other embodiments, the following modifications may be made to this embodiment:

1. The second terminal of the second switch 4 may be coupled to the first terminal of the secondary winding 12, and the output capacitor 5 may be coupled between the first terminal of the second switch 4 and the second terminal of the secondary winding 12.

2. The predetermined time threshold (Tth) may be omitted. In this case, the first switch 2 may transition from the OFF state to the ON state when the voltage across the first switch 2 (Vds1) is determined, in response to the voltage at the first terminal of the auxiliary winding 13 (Vaux), to reach its valley, and the second time period may be always right after the first time period.

3. The voltage detection signal may be omitted. In this case, the duration of the second time period may be predetermined according to Equation 1 in a design phase of the flyback converter.

In the description above, for the purposes of explanation, numerous specific details have been set forth in order to provide a thorough understanding of the embodiment. It will be apparent, however, to one skilled in the art, that one or more other embodiments may practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connect ion with what is considered the exemplary embodiment(s), it is understood that the disclosure is not limited to the disclosed embodiment but is intended to cover various arrangements included within the spirit and scope of the broadest interpretation so as to encompass all such modifications and equivalent arrangements.

What is claimed is:

1. A flyback converter comprising:
a transformer including a primary winding and a secondary winding, each of the windings having a first terminal and a second terminal, the first terminals respectively of the primary and secondary windings having the same voltage polarity;
a first switch coupled to the first terminal of the primary winding;
a first control module coupled to the first switch, and configured to control the first switch;
a second switch coupled to the secondary winding; and
a second control module coupled to the second switch, and configured to control the second switch, such that the second switch operates in an ON state during a first time period and during a second time period which is right after the first time period, and such that a current flowing through the secondary winding has a direction during the second time period opposite to that during the first time period.

2. The flyback converter of claim 1, wherein the second control module controls the second switch in response to a voltage across the second switch.

3. The flyback converter of claim 2, wherein, in the first time period, the direction of the current flowing through the secondary winding is determined, in response to the voltage across the second switch, to be from the second terminal of the secondary winding to the first terminal of the secondary winding.

4. The flyback converter of claim 1, wherein the transformer further includes an auxiliary winding having a first terminal and a second terminal; and
the first control module is coupled further to the first terminal of the auxiliary winding, and controls the first switch in response to a voltage at the first terminal of the auxiliary winding.

5. The flyback converter of claim 4, wherein the first switch transitions from an OFF state to an ON state when a voltage across the first switch is determined, in response to the voltage at the first terminal of the auxiliary winding, to reach its valley.

6. The flyback converter of claim 1, wherein the primary winding is configured to receive an input voltage at the second terminal thereof; and
the second control module further generates, in response to a voltage across the second switch, a voltage detection signal indicating the input voltage, and controls the second switch in response to the voltage detection signal.

7. The flyback converter of claim 6, wherein the second time period has a duration that is a function of the input voltage.

8. The flyback converter of claim 1, wherein the second time period includes a range of 0.1 μs to 3 μs in duration.

9. A flyback converter comprising:
a transformer including a primary winding and a secondary winding, each of the windings having a first terminal and a second terminal, the first terminals respectively of the primary and secondary windings having the same voltage polarity;
a first switch coupled to the first terminal of the primary winding;
a first control module coupled to the first switch, and configured to control the first switch;
a second switch coupled to the secondary winding; and
a second control module coupled to the second switch, and configured to control the second switch, such that the second switch operates in an ON state during a first time period and during a second time period which follows the first time period, and such that a current flowing through the secondary winding has a direction during the second time period opposite to that during the first time period.

10. The flyback converter of claim 9, wherein the second control module controls the second switch in response to a voltage across the second switch.

11. The flyback converter of claim 10, wherein in the first time period, the direction of the current flowing through the secondary winding is determined, in response to the voltage across the second switch, to be from the second terminal of the secondary winding to the first terminal of the secondary winding.

12. The flyback converter of claim 9, wherein the second control module controls the second switch in response to a predetermined time threshold.

13. The flyback converter of claim 12, wherein, when the first time period is determined to have a duration greater than the predetermined time threshold, the second time period starts from an end of the first time period.

14. The flyback converter of claim 13, wherein the second control module controls the second switch in response further to a voltage across the second switch.

15. The flyback converter of claim 14, wherein, when the duration of the first time period is determined to be less than the predetermined time threshold, the second time period starts from a time point which lags a start of the first time period by at least the predetermined time threshold, and at which the voltage across the second switch is determined to reach its valley.

16. The flyback converter of claim 15, wherein the transformer further includes an auxiliary winding having a first terminal and a second terminal; and
the first control module is coupled further to the first terminal of the auxiliary winding, and controls the first switch in response to a voltage at the first terminal of the auxiliary winding and the predetermined time threshold.

17. The flyback converter of claim 16, wherein the first switch operates in an OFF state for at least the predetermined time threshold, and transitions from the OFF state to an ON state when a voltage across the first switch is determined, in response to the voltage at the first terminal of the auxiliary winding, to reach its valley.

18. The flyback converter of claim 9, wherein the primary winding is configured to receive an input voltage at the second terminal thereof; and
the second control module further generates, in response to a voltage across the second switch, a voltage detection signal indicating the input voltage, and controls the second switch in response to the voltage detection signal.

19. The flyback converter of claim 18, wherein the second time period has a duration that is a function of the input voltage.

20. The flyback converter of claim 9, wherein the second time period includes a range of 0.1 μs to 3 μs in duration.
